(19) United States
(12) Patent Application Publication
(10) Pub. No.: US 2019/0190739 A1
(43) Pub. Date: Jun. 20, 2019

(54) NON-INTRUSIVE HARDWARE ADD-ON TO ENABLE AUTOMATIC SERVICES FOR APPLIANCES

(71) Applicant: EVRYTHNG Limited, London (GB)

(72) Inventors: Dominique David Guinard, Yverdon-les-Bains (CH); Joël Antoine Ghislain Vogt, London (GB); Curtis Schacker, Piedmont, CA (US); Niall Terence Murphy, Commugny (CH)

(21) Appl. No.: 16/199,368

(22) Filed: Nov. 26, 2018

Related U.S. Application Data
(60) Provisional application No. 62/592,315, filed on Nov. 29, 2017.

(51) Int. Cl. H04L 12/28; G05B 15/02; G06N 20/00

(52) U.S. Cl. CPC H04L 12/283; G06N 20/00; G05B 15/02

(57) ABSTRACT

A system includes a controller including hardware comprising at least one processor and a memory. The controller receives information from at least one sensor. At least one sensor is constructed and adapted to sense, non-intrusively, real-world physical information associated with at least one appliance. Based at least in part on the information from at least one sensor, the controller determines a current condition of at least one appliance and/or predicts a future condition of at least one appliance. Based at least in part on (i) the current condition of at least one appliance and/or (ii) the predicted future condition of at least one appliance, the controller initiates at least one intervention with at least one appliance.

### RELATED APPLICATIONS

This application is related to and claims priority from co-pending U.S. provisional patent application No. 62/592,315, filed Nov. 29, 2017, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention generally relates to determination and/or prediction of current and/or of future conditions of an appliance based on sensed aspects of the appliance, and to possible interventions based on such determinations and predictions.

### BACKGROUND

Appliances have a given life cycle, after which they may be prone to breakage. While preventive maintenance and repairs may avoid appliance breakage, a particular appliance may often go without preventive maintenance because such service may not have been identified as necessary. This delay in preventive maintenance may lead to the appliance breaking down and needing expensive repair or even replacement.

In addition to breakage, some appliances need replenishment of consumables (e.g., paper or ink for printers, coffee beans for coffee makers, etc.). While some appliances may give warnings when they are running low on a consumable, many appliances may run out of consumables without any warning or alerting the user in a sufficiently useful time beforehand As such, these appliances may be out of operation while consumables are ordered, shipped, received, and installed.

Accordingly, there is a need to predict when an appliance may need an intervention (such as a service call, replenishment of consumables, etc.). There is also a need to automatically provide or initiate required interventions.

It is desirable, and an object of this invention, to provide an automated system that may determine the condition of a particular appliance, predict if and when the appliance may require a particular intervention, and to then fulfill the intervention.

It is also desirable and an object of this invention to determine information about existing appliances without modifying the appliances.

### SUMMARY

The present invention is specified in the claims as well as in the below description. Preferred embodiments are particularly specified in the dependent claims and the description of various embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a system including a controller including hardware including at least one processor and a memory, and the controller may be constructed and adapted to (a) receive information from at least one sensor, where said at least one sensor is constructed and adapted to sense, non-intrusively, real-world physical information associated with at least one appliance. The controller may also be constructed and adapted to, (b) based at least in part on said information from at least one sensor, (b)(1) determine a current condition of at least one appliance and/or (b)(2) predict a future condition of at least one appliance. The controller may also be constructed and adapted to, (c) based at least in part on (i) said current condition of at least one appliance determined in (b)(1) and/or (ii) said predicted future condition of at least one appliance determined in (b)(2), initiate at least one intervention with at least one appliance. Other embodiments of this aspect include corresponding computer systems, apparatus, and computer programs recorded on one or more computer storage devices, each configured to perform the actions of the methods.

Implementations may include one or more of the following features, alone or in combination:
The system where at least one sensor is constructed and adapted to sense real-world physical information associated with said at least one appliance without interaction or interference or intervention, operationally or functionally, with said at least one appliance.
The system where the real-world physical information associated with at least one appliance includes information associated with at least one appliance's environment.
The system where at least one sensor senses one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and/or nitrogen.
The system where at least one appliance is selected from a group including: coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters.
The system where one or more sensors of said at least one sensor is associated with multiple appliances of said at least one appliance.
The system where multiple sensors of said at least one sensor are associated with a particular appliance of said at least one appliance.
The system where at least one intervention includes one or more actions selected from a group including: turn off said at least one appliance, initiate replenishment of a supply of said at least one appliance, initiate service or maintenance of said at least one appliance, initiate replacement of a part of said at least one appliance, configure said at least one appliance, and provide information about said appliance to a third party.
The system where said future condition of at least one appliance is predicted in (b)(2) based on one or more of: information learned from other appliances, prior sensed data, measurements, prior predictions, manufacturer models, and external sources.
The system where said external sources include one or more of: weather reports, temperature readings from thermostats, manufacturer data.
The system where said at least one sensor is constructed and adapted to non-intrusively sense real-world physical information associated with said at least one appliance.
The system where one or more sensors of said at least one sensor are add-ons to one or more of said at least one appliance.
The system where one or more sensors of said at least one sensor are attached to one or more of said at least one appliance.
The system where one or more sensors of said at least one sensor are apart from one or more of said at least one appliance.
The system where said controller is further constructed and adapted to: (d) initiate at least one intervention with at least one non-monitored appliance based, at least in part, on (i) a current condition of at least one monitored appliance determined in (b)(1) and/or (ii) a predicted future condition of at least one monitored appliance determined in (b)(2).
The system where said predicted future condition of at least one appliance is determined based on a history of other appliances.
The system where the controller receives information in (a) wirelessly from at least one sensor.

One general aspect includes a computer-implemented method, on a controller including hardware including at least one processor and a memory, the method including, by the controller: (a) receiving information from at least one sensor, where said at least one sensor is constructed and adapted to sense, non-intrusively, real-world physical information associated with at least one appliance; (b) based at least in part on said information from at least one sensor. The computer-implemented method may also include (b)(1) determining a current condition of at least one appliance and/or. The computer-implemented method may also include (b)(2) predicting a future condition of at least one appliance. The computer-implemented method also includes (c)based at least in part on (i) said current condition of at least one appliance determined in (b)(1) and/or (ii) said predicted future condition of at least one appliance determined in (b)(2), initiating at least one intervention with at least one appliance. Other embodiments of this aspect include corresponding computer systems, apparatus, and computer programs recorded on one or more computer storage devices, each configured to perform the actions of the methods.

One general aspect includes an article of manufacture including non-transitory computer-readable media having computer-readable instructions stored thereon, the computer-readable instructions including instructions for implementing a computer-implemented method, said method operable on a device including hardware including memory and at least one processor and running a service on said hardware, said method including the method noted above on any of the systems noted above.

One general aspect includes a sensor module including: one or more sensors. The sensor module also includes a communication mechanism. The sensor module also includes a controller, including at least one processor and a memory. The sensor module also includes where said one or more sensors are constructed and adapted to sense, non-intrusively, real-world physical information associated with at least one appliance. The sensor module also obtains sensor information from said one or more sensors. The sensor module also provides sensor data to a system distinct from said sensor module, where said sensor data is based on and/or derived from said sensor information.

Implementations may include one or more of the following features:
The sensor module where the sensor is constructed and adapted to sense real-world physical information associated with said at least one appliance without interaction or interference or intervention, operationally or functionally, with said at least one appliance.
The sensor module where said one or more sensors monitor physical aspects of a single appliance and/or an environment of said single appliance.
The sensor module where said one or more sensors monitor: (i) physical aspects of multiple appliances, and/or (ii) an environment of said multiple appliances.
The sensor module where said controller provides said sensor data to said system using said communication mechanism.
The sensor module where the sensor module is an add-on to said at least one appliance.
The sensor module where the sensor module is attached to said at least one appliance.
The sensor module where the sensor module is apart and/or remote from said at least one appliance.
The sensor module where the at least one appliance is selected from a group including: coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters.
The sensor module where the one or more sensors sense one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and/or nitrogen.
The sensor module where the sensor module operates independent of said at least one appliance.
The sensor module where the sensing module is configured to continually monitor said at least one appliance.
The sensor module where the sensing module is configured to periodically monitor said at least one appliance.
The sensor module where the sensing module is configured to periodically monitor said at least one appliance and then to switch from a periodic monitoring mode to a continual monitoring mode upon sensing a particular output or type of output from the at least one appliance.
The sensor module where sensing module is configured to continually send data that the sensing module collects from the at least one appliance to the system.
The sensor module where sensing module is configured to parameterize and/or categorize and/or manipulate and/or filter and/or process sensor information obtained from said one or more sensors prior to sending the sensor data to the system.
The sensor module where the communication mechanism includes a receiver, and where the sensor module is further constructed and adapted to receive, via said receiver, commands to be processed and/or executed by the controller.
The sensor module where the commands include a command to switch the sensor module to a low power consumption and/or battery conservation mode.

Implementations of the described techniques may include hardware, a method or process, or computer software on a computer-accessible medium.

Below is a list of system aspects. Those will be indicated with a letter “S”. Whenever such aspects are referred to, this will be done by referring to “S” aspects.
S1. A system comprising:
   a controller including hardware comprising at least one processor and a memory, and controller constructed and adapted to:
   (a) receive information from at least one sensor, wherein said at least one sensor is constructed and adapted to sense, non-intrusively, real-world physical information associated with at least one appliance;
   (b) based at least in part on said information from at least one sensor,
      (b)(1) determine a current condition of at least one appliance and/or
      (b)(2) predict a future condition of at least one appliance; and
   (c) based at least in part on (i) said current condition of at least one appliance determined in (b)(1) and/or (ii) said predicted future condition of at least one appliance determined in (b)(2), initiate at least one intervention with at least one appliance.
S1′ The system as in aspect S1, where said at least one sensor is constructed and adapted to sense real-world physical information associated with said at least one appliance without interaction or interference or intervention, operationally or functionally, with said at least one appliance.
S2. The system as in aspect S1, wherein the real-world physical information associated with at least one appliance includes information associated with at least one appliance's environment.
S3. The system as in aspects S1 or S2, wherein at least one sensor senses one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and/or nitrogen.
S4. The system of any one of the previous system aspects, wherein at least one appliance is selected from a group comprising: coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters.
S5. The system of any one of the previous system aspects, wherein one or more sensors of said at least one sensor is associated with multiple appliances of said at least one appliance.
S6. The system of any one of the previous system aspects, wherein multiple sensors of said at least one sensor are associated with a particular appliance of said at least one appliance.
S7. The system of any one of the previous system aspects, wherein at least one intervention comprises one or more actions selected from a group comprising: turn off said at least one appliance, initiate replenishment of a supply of said at least one appliance, initiate service or maintenance of said at least one appliance, initiate replacement of a part of said at least one appliance, configure said at least one appliance, and provide information about said appliance to a third party.
S8. The system of any one of the previous system aspects, wherein said future condition of at least one appliance is predicted in (b)(2) based on one or more of: information learned from other appliances, prior sensed data, measurements, prior predictions, manufacturer models, and external sources.
S9. The system of system aspect S8, wherein said external sources include one or more of: weather reports, temperature readings from thermostats, manufacturer data.
S10. The system of any one of the previous system aspects, wherein said at least one sensor is constructed and adapted to non-intrusively sense real-world physical information associated with said at least one appliance.
S11. The system of any one of the previous system aspects, wherein one or more sensors of said at least one sensor are add-ons to one or more of said at least one appliance.
S12. The system of any one of the previous system aspects, wherein one or more sensors of said at least one sensor are attached to one or more of said at least one appliance.
S13. The system of any one of the previous system aspects, wherein one or more sensors of said at least one sensor are apart from one or more of said at least one appliance.
S14. The system of any one of the previous system aspects, wherein said controller is further constructed and adapted to:
   (d) initiate at least one intervention with at least one non-monitored appliance based, at least in part, on (i) a current condition of at least one monitored appliance determined in (b)(1) and/or (ii) a predicted future condition of at least one monitored appliance determined in (b)(2).
S15. The system of any one of the previous system aspects, wherein said predicted future condition of at least one appliance is determined based on a history of other appliances.
S16. The system of any one of the previous system aspects, wherein the controller receives information in (a) wirelessly from at least some of the sensors.

Below are some method aspects. Those will be indicated with a letter “M”.
M17. A computer-implemented method, on a controller including hardware comprising at least one processor and a memory, the method comprising, by the controller:
   (A) receiving information from at least one sensor, wherein said at least one sensor is constructed and adapted to sense, non-intrusively, real-world physical information associated with at least one appliance;
   (B) based at least in part on said information from at least one sensor,
      (B)(1) determining a current condition of at least one appliance and/or
      (B)(2) predicting a future condition of at least one appliance; and
      (C) based at least in part on (i) said current condition of at least one appliance determined in (B)(1) and/or (ii) said predicted future condition of at least one appliance determined in (B)(2), initiating at least one intervention with at least one appliance.
M17′. A computer-implemented method on the system of any one of the systems S1-S16.

Below are article of manufacture aspects, indicated with a letter “A”.
A18. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of any one of the systems S1-S16.

Below is a list of sensor module aspects. Those will be indicated with a letters “SM”. Whenever such aspects are referred to, this will be done by referring to “SM” aspects.
SM19. A sensor module comprising:
one or more sensors, a communication mechanism; and a controller, comprising at least one processor and a memory,
wherein said one or more sensors are constructed and adapted to sense, non-intrusively, real-world physical information associated with at least one appliance, and wherein said controller:
(a) obtains sensor information from said one or more sensors; and
(b) provides sensor data to a system distinct from said sensor module, wherein said sensor data is based on and/or derived from said sensor information.
SM19′ The sensor module as in SM191, where said at least one sensor is constructed and adapted to sense real-world physical information associated with said at least one appliance without interaction or interference or intervention, operationally or functionally, with said at least one appliance.
SM20. The sensor module of the previous sensor module aspects, wherein said one or more sensors monitor physical aspects of a single appliance and/or an environment of said single appliance.
SM21. The sensor module of any one of the previous sensor module aspects SM19-SM20, wherein said one or more sensors monitor: (i) physical aspects of multiple appliances, and/or (ii) an environment of said multiple appliances.
SM22. The sensor module of any one of the previous sensor module aspects SM19-SM21, wherein said controller provides said sensor data to said system using said communication mechanism.
SM23. The sensor module of any one of the previous sensor module aspects SM19-SM22, wherein the sensor module is an add-on to said at least one appliance.
SM24. The sensor module of any one of the previous sensor module aspects SM19-SM23, wherein the sensor module is attached to said at least one appliance.
SM25. The sensor module of any one of the previous sensor module aspects SM19-SM24, wherein the sensor module is apart from said at least one appliance.
SM26. The sensor module of any one of the previous sensor module aspects SM19-SM25, wherein the at least one appliance is selected from a group comprising: coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters.
SM27. The sensor module of any one of the previous sensor module aspects SM19-SM26, wherein the one or more sensors sense one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and/or nitrogen.
SM28. The sensor module of any one of the previous sensor module aspects SM19-SM27, wherein the sensor module operates independent of said at least one appliance.
SM29. The sensor module of any one of the previous sensor module aspects SM19-SM28, wherein the sensing module is configured to continually monitor said at least one appliance.
SM30. The sensor module of any one of the previous sensor module aspects SM19-SM29, wherein the sensing module is configured to periodically monitor said at least one appliance.
SM31. The sensor module of any one of the previous sensor module aspects SM19-SM30, wherein the sensing module is configured to periodically monitor said at least one appliance and then to switch from a periodic monitoring mode to a continual monitoring mode upon sensing a particular output or type of output from the at least one appliance.
SM32. The sensor module of any one of the previous sensor module aspects SM19-SM31, wherein sensing module is configured to continually send data that the sensing module collects from the at least one appliance to the system.
SM33. The sensor module of any one of the previous sensor module aspects SM19-SM32, wherein sensing module is configured to parameterize and/or categorize and/or manipulate and/or filter and/or process sensor information obtained from said one or more sensors prior to sending the sensor data to the system.
SM34. The sensor module of any one of the previous sensor module aspects SM19-SM33, wherein the communication mechanism comprises a receiver, and wherein the sensor module is further constructed and adapted to
receive, via said receiver, commands to be processed and/or executed by the controller.
SM35. The sensor module of the previous sensor module aspect SM34, wherein the commands include a command to switch the sensor module to a low power consumption and/or battery conservation mode.

The above features, along with additional details of the invention, are described further in the examples herein, which are intended to further illustrate the invention but are not intended to limit its scope in any way.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings is to scale unless specifically stated otherwise.

FIGS. 1A-1C depicts aspects of systems according to exemplary embodiments hereof;

FIG. 2 depicts aspects of a sensing module according to exemplary embodiments hereof;

FIGS. 3A-3C depict aspects of sensors according to exemplary embodiments hereof;

FIG. 4 depicts aspects of a software platform according to exemplary embodiments hereof; and

FIG. 5 shows an exemplary data model.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

The term “mechanism,” as used herein, refers to any device(s), process(es), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

The term “appliance” refers to any device(s) or equipment designed generally to perform any task or tasks. An appliance may be or comprise a device, machine, instrument, gadget, contraption, apparatus, utensil, tool, mechanism, or any other type of device or any combination thereof. An appliance may comprise hardware and/or software and may be formed from other appliances. As non-limiting examples, an appliance may be or comprise a coffee machine, wind turbine, water cooler, water dispensing fridge, filtration system (e.g., a whole house filtration system), boiler, postbox, dishwasher, vacuum cleaner (e.g., vacuum cleaner bag), dryer filter, washing machine, sparkling water dispenser, soda dispenser, oven filter, cat basket/toilet, pet food dispenser, pet food, refrigerator, air conditioner, a central heating pellet boiler, computer, or a printer. An appliance may be used commercially, industrially, or by consumers (e.g., residentially).

Overview

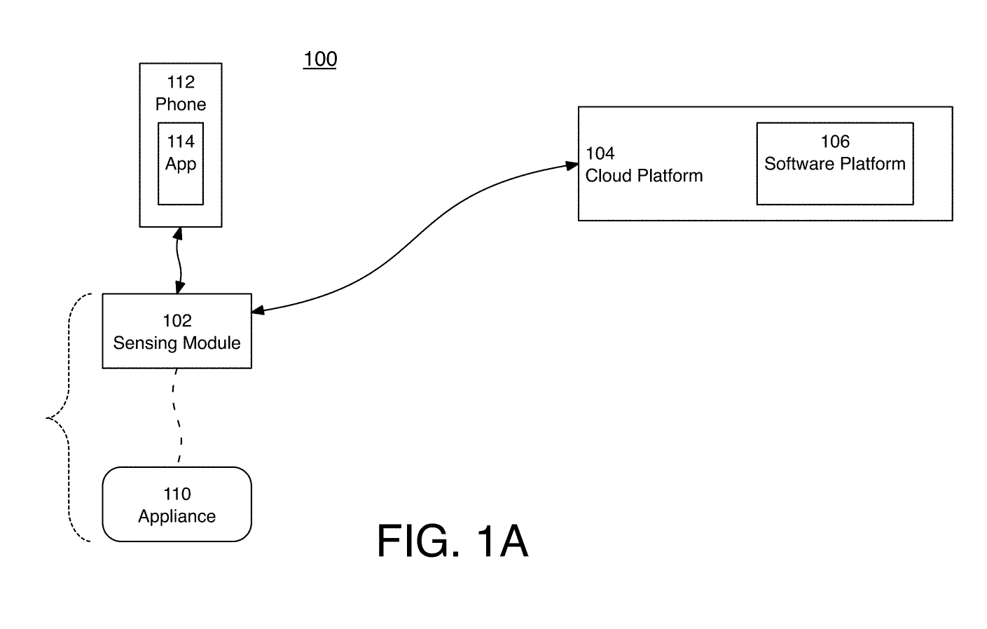

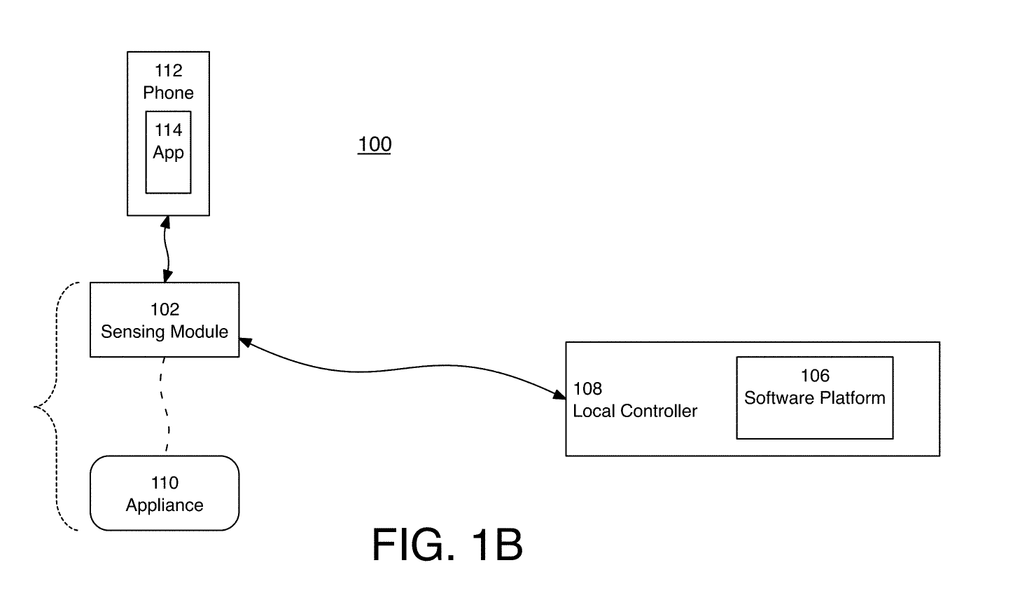

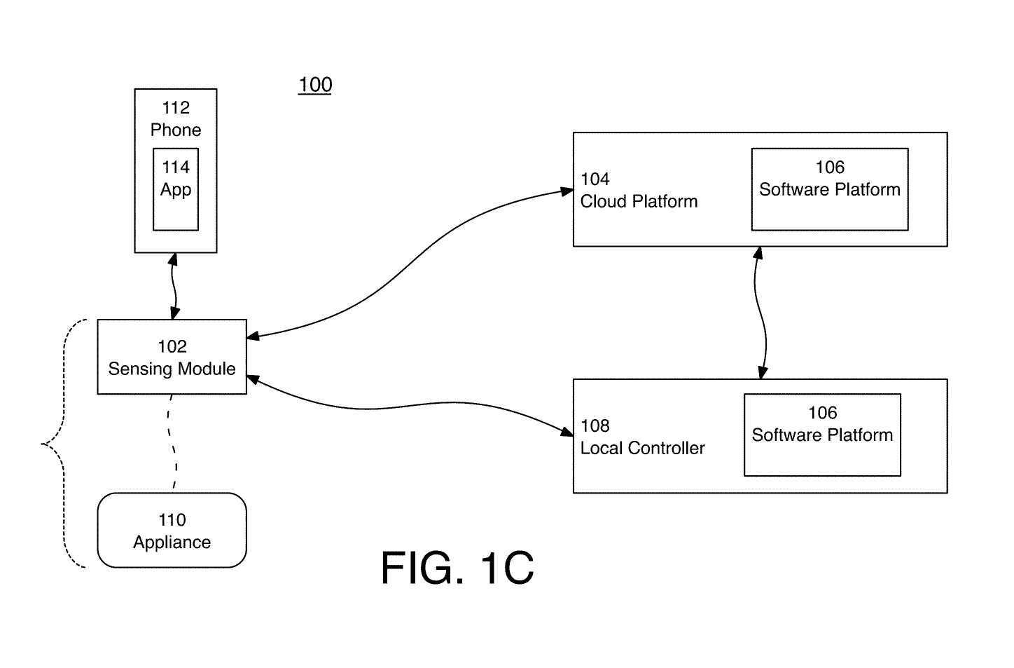

A system or framework according to exemplary embodiments hereof is described here with reference to the drawings of FIGS. 1A-1C, 2, 3A-3C, and 4.

With reference to FIG. 1A, preferred embodiments of the system 100 may include one or more sensing modules 102, a cloud platform 104, and software system or platform 106. In other exemplary embodiments, e.g., as shown in FIG. 1B, the system 100 may include a local controller 108 and a software system or platform 106. In still other exemplary embodiments, e.g., as shown in FIG. 1C, the system 100 may include both a cloud platform 104 and a local controller 108, each including a software system or platform 106.

Thus, a system 100 may include a cloud platform 104 without a local controller 108, a local controller 108 without a cloud platform 104, or both a cloud platform 104 and a local controller 108.

A sensing module 102 may be associated or configured (preferably non-intrusively) with an appliance 110. This association/configuration is depicted as a dashed line in FIGS. 1A-1C. As explained below, a sensing module 102 may be attached to an appliance 110 or it may sense aspects of the appliance without being attached and remote from the appliance.

As used herein, the term “non-intrusive” (or “non-intrusively”) means without operational and/or functional interference, intervention, or interaction. Thus, e.g., a non-intrusive sensing module may sense and/or measure aspects of an appliance without interfering or interacting or intervening with the appliance's operation or function.

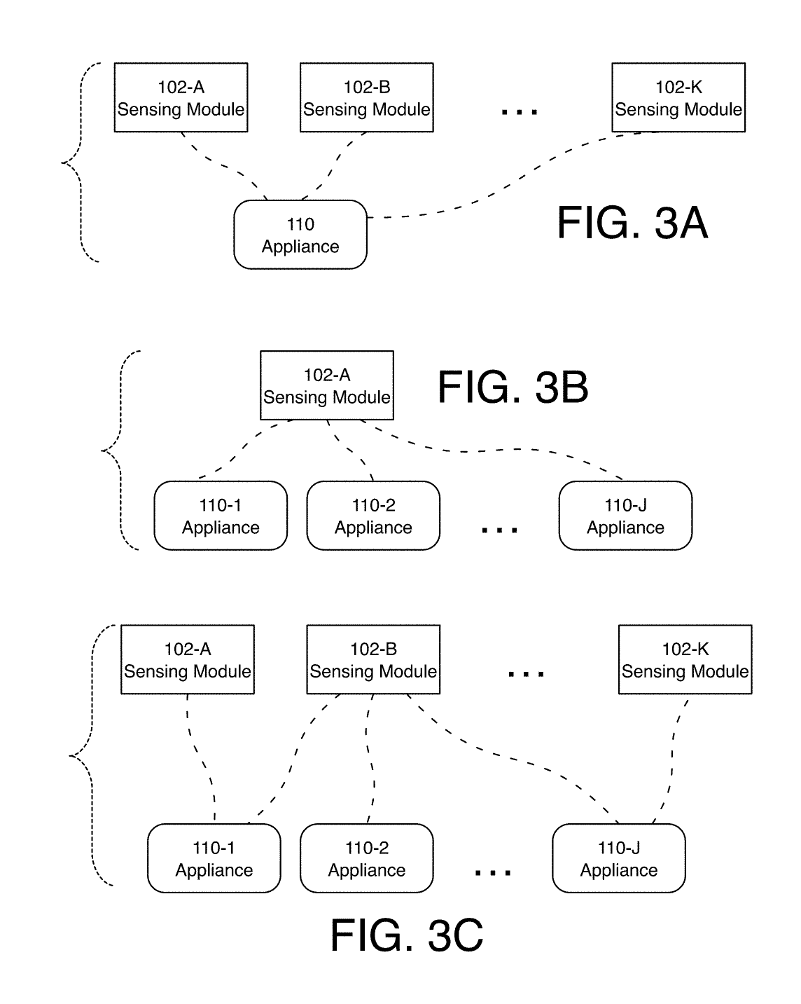

Although only one sensing module is shown in the drawing in FIGS. 1A-1C, it should be appreciated that a system 100 may include multiple sensing modules associated with multiple appliances. A particular sensing module may be associated with one or more appliances, and a particular appliance may have more than one sensing module associated therewith. FIGS. 3A-3C show exemplary configurations of sensing modules and appliances. As shown in the example configuration in FIG. 3A, multiple sensing modules (102-A, 102-B . . . 102-K) are associated with a single appliance 110. In the example configuration in FIG. 3B, a single sensing module 102-A is associated with multiple appliances 110-1, 110-2 . . . 110-J. In the example configuration in FIG. 3C, some sensing modules are associated with a single appliance and other sensing modules are associated with multiple appliances, while some appliances are associated with a single sensing module, while others are associated with multiple sensing modules. Those of ordinary skill in the art will realize and appreciate, upon reading this description, that the configurations of FIGS. 3A-3C are only examples, and do not limit the scope of the invention.

When there are multiple sensing modules associated with a particular appliance, the sensing modules may be configured to sense different aspects or things about the appliance.

As shown in FIGS. 1A-1C, system 100 may also include an electronic device 112 such as a smailphone, a tablet computer, or other type of device that may include an application mechanism 114 (also referred to herein as an “application” or “app”) that may be used to configure or otherwise interface with the sensing module 102, cloud platform 104, and/or local controller 108.

Various components or parts of the system 100 are described now in greater detail.

Sensing Module

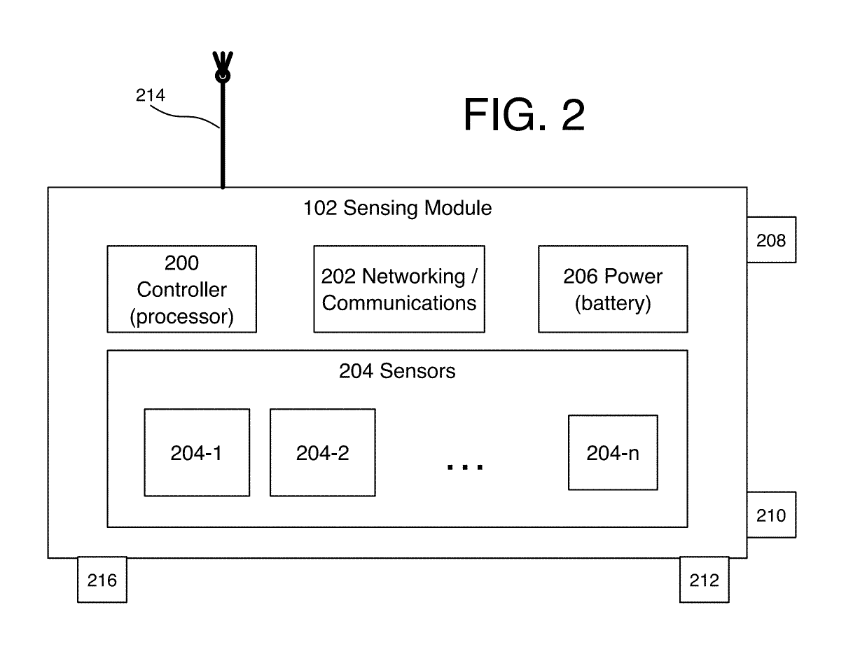

With reference to FIG. 2, a sensing module 102 according to exemplary embodiments hereof may include a controller 200 (e.g., a microprocessor), a networking/communications module 202, and one or more sensors 204-1, 204-2 . . . 204-n (collectively and individually sensor(s) 204). The sensor(s) 204 may include one or more sensor controllers (not shown) that may control sensors 204. The sensor controller(s) may include drivers that may allow the sensor controller(s) and/or controller 200 to control the sensors 204.

A sensor 204 preferably senses a real-world physical attribute (e.g., motion, orientation, pressure, humidity, sound, temperature, electromagnetic radiation (e.g., X-rays, light, radio waves, microwaves, etc.), etc.). Each sensor 204 may be constructed and adapted to sense one or more physical features or aspects of one or more appliances associated with the sensing module as well as aspects of the sensing module itself (e.g., its temperature or orientation or movement), its surrounding environment, etc.

Sensors 204 may include but are not limited to vibration sensors, motion sensors, orientation sensors, pressure sensors, humidity sensors, audio sensors (e.g., microphones), temperature sensors, speed sensors, acceleration sensors, pressure sensors, light sensors, radiation sensors, RF sensors, microwave sensors, millimeter wave sensors, or other types or combinations of types of sensors. The types of sensors 204 (and corresponding sensor controllers) configured with each sensing module 102 may be selected depending on the characteristics that may need to be sensed to monitor an appliance 110 that may be configured with the sensing module 102.

For example, a sensing module 102 may include one or more vibration sensors 204 in order to sense vibrations associated with an appliance and/or its operation and environment. An exemplary sensing module 102 may include a microphone or other sound sensors 204 in order to sense sounds associated with an appliance and/or its operation.

As should be appreciated, a sensing module 102 may include multiple sensors 204 (e.g., one or more vibration sensors and one or more sound sensors). As should also be appreciated, the sensors 204 may include multiple sensors to sense the same physical attribute (e.g., multiple vibration sensors, multiple sound sensors, etc.). These multiple sensors may be included for redundancy or to sense or measure a particular physical attribute in different ways, at different levels, or to different degrees of accuracy.

The sensing module 102 preferably includes an internal power source 206 (e.g., a battery), and/or an external power connector 208 that may be plugged into an external power source (e.g., an AC power outlet) to provide power to sensing module 102. The internal power source 206 may be a rechargeable battery or the like. Other forms and/or sources of power are contemplated (e.g., harvesting energy from solar power, wave power, wind power, vibrations, electromagnetic fields, etc.), and the module is not limited by the manner in which it is powered.

The sensing module 102 may include an on/off power or reset switch 210, and a switch 212 to switch between the internal power source 206 (e.g., battery) and the external power connector 208. Switching between internal and external power sources may be automatic.

The sensing module 102 may also include at least one antenna 216 to receive/transmit signals to the local controller 108 or to other devices, e.g., via the networking/communications module 202.

The sensing module 102 may include a network on/off switch 218, as well as other components or elements necessary for it to perform its desired functions.

A sensing module 102 according to exemplary embodiments hereof may be configured and/or positioned or attached such that sensors 204 may sense one or more aspects of an associated appliance 110 (e.g., particular information about and/or outputs from an appliance 110 and/or about the environment in which the appliance is situated and/or operating).

For example, a sensing module may be positioned to sense vibrations from a dishwasher. In another example, a sensing module may be positioned to sense sound generated when a user presses the button of a water dispenser (the sound could be the sound of flowing water and/or the sound of a click of a button). Other examples of sensed information may include the sound of wind interacting with the blades of a wind turbine, or the vibrations generated by a coffee machine or clothes dryer when in operation.

Preferably the sensing module 102 is configured with the appliance 110 in a non-intrusive, aesthetically pleasing and fully functional manner This may relate to the physical design of the sensing module 102, the setup and pairing of the sensing module 102 with the appliance 110, and the remote data collection performed by the sensing module 102. The sensing module 102 may be designed to blend into and be compatible with the appliance environment (e.g., operate in living spaces or in harsh environments outdoors), may require minimal or no user setup, and may operate fully autonomously for a prolonged period (years) preferably on a single battery. As noted above, the sensing module 102 may also use other types of power sources and may be plugged directly into a power outlet.

While a sensing module 102 may be embedded, implanted, or otherwise integrated into the appliance 110 (during or after manufacturing), preferably the sensing module 102 is an add-on to any existing appliance 110, adding sensing and communication capabilities to the appliance 110. In this way, sensing module 102 may be preferably attached or generally configured/adapted to the appliance 110 in a way as to be non-intrusive. For example, the sensing module 102 may include a magnet that may allow for the module 102 to be placed on and adhered to a metallic internal or external surface of the appliance 110. Other types of attachment methods or mechanisms such as clamps, bands, tape or other types of attachment means may also be used. In some cases, a sensing module 102 may be located nearby an appliance without actually touching the appliance. Those of ordinary skill in the art will appreciate and understand, upon reading this description, that the placement of a sensing module 102 will depend on the appliance and the physical parameters to be sensed.

As noted, a sensing module 102 may be attached to an appliance 110 or it may sense aspects of the appliance without being attached and remote from the appliance. For example, a sensing module may use one or more sensors such as microphone(s) and/or camera(s) (e.g., infrared cameras) to sense aspects of one or more appliances. For example, an infrared camera could observe a coffee machine to detect its activities based on its heat signature Remote sensing allows for easier use of one sensor to monitor multiple appliances (e.g., as depicted in FIG. 3B and sensing module 102-B in FIG. 3C). Remote sensing may also be appropriate when the appliance(s) to be monitored is (are) inaccessible, e.g., for safety or security reasons.

The controller 200 may include a CPU, microprocessor, a microcontroller or other type of processor as well as any other components or devices (such as a chipset, control board, RAM, general memory, power supplies, etc.) necessary to operate and generally perform its functions. The networking/communications module 202 (including, e.g., transmitters/receivers) may include a network card or the like that may enable sensing module 102 to communicate with cloud platform 104 and/or local controller 108 over a network such as a Local Area Network (LAN), an Internet network (possibly through a modem), an Internet of Things (IoT) network e.g., PAN (Personal Area Network) or LPWAN (Low-Power Wide Area Network) or any other type(s) of network. The sensing module 102 may communicate over such network(s) via wireless technology, Wi-Fi, Bluetooth, LoRA, telephony, RF, microwave, optical, via transmission lines, or by other means or combinations thereof. The networking/communications module 202 may also include an RF transmitter/receiver, an optical transmitter/receiver, a microwave transmitter/receiver, and/or any other type of transmitter/receiver, such that the sensing module 102 may connect and generally communicate with the cloud platform 104 and/or a local controller 108 via these communication protocols.

With a sensing module 102 configured with an appliance 110, sensors 204 may sense, monitor and generally receive outputs or information from or about the appliance 110 or information about the appliance's environment and operation (or lack thereof). The sensed information may include, e.g., vibrations, sounds, temperature variations, etc.

A sensing module 102 may be configured to continually monitor the appliance 110 or it may be configured to periodically monitor the appliance 110, e.g., on a predetermined frequency or schedule. Alternatively, a sensing module 102 may be configured to switch from periodic monitoring mode to a continual monitoring mode upon the sensing of a particular output or type of output from the appliance 110 that may indicate a potential problem with the appliance 110 (e.g., a particular sound or high intensity vibration). In any event, sensing module 102 may sense information from the appliance 110 that it may then transmit to the cloud platform 104 and/or the local controller 108, or that it may process using its controller 200. The sensing module 102 may be configured to continually send or otherwise transmit all of the data that the sensing module 102 may collect from the appliance 110 to the cloud platform 104 and/or the local controller 108. Alternatively, in some exemplary embodiments, the module 102 may have the ability to parameterize, categorize, manipulate, filter, or otherwise process the sensed data on the module 102 prior to sending the data to the cloud platform 104 and/or local controller 108. In this way, the module 102 may determine what data may have a higher probability of representing a need for an intervention and may send or otherwise transmit this categorized data to the cloud platform 104 and/or the local controller 108 for analysis. Once sent to the cloud platform 104 and/or local controller 108, the data may be analyzed, e.g., as described herein.

A sensor 204 (e.g., in conjunction with a sensor controller) may process raw information that it senses (e.g., by sampling, scaling, etc.).

In addition, in some exemplary embodiments hereof, the sensing module 102 may be able to receive data, commands or other information from the cloud platform 104 and/or the local controller 108. The sensing module 102 may receive the information via a receiver/transmitter in its networking/communications module 202 and the information, data or commands may be processed and/or executed by the sensor module's controller 200.

In one example, the cloud platform 104 may send a command to the sensing module 102 via a wireless connection (such as Wi-Fi or LPWAN via an Internet modem and router) to switch into a low power consumption/battery conservation mode while the system 100 waits for an appliance intervention to be initiated and executed (e.g., while it awaits maintenance, repair or for the replenishment of supplies/components for the monitored appliance 110). Upon receiving the command, the sensing module 102 may execute the command and may switch into the new mode. Other types or combinations of types of commands may also be issued by the cloud platform 104 and/or external local controller 108 to the sensing module 102 for execution.

The sensing module 102 may also include visual or audio notifications that may alert the user to various operating conditions. For example, the sensing module 102 may include an LED indicator light that may indicate that the system 100 may be operating correctly. The sensing module 102 may also include a second LED indicator light that may indicate that there may be a problem with the sensing module 102 or with the local controller 108 or with any other component of system 100. Yet another indicator light may indicate that the sensing modules 102 may be on the network and communicating with the cloud platform 104, or that there may be a problem with the network or Internet connection. Other types of indicator lights may also be used for other types of indications.

The types, configurations and modes of the sensor modules 102 as described above are described for the purposes of aiding this description, and those of ordinary skill in the art will realize and appreciate, upon reading this description, that different and/or other types of sensing modules 102, configurations of sensing modules 102 and/or sensors 204 may be used. It should also be appreciated that any particular sensing module 102 or sensor 204 may be configured in more than one way. Similarly, it should be appreciated that different and/or other sensor modules 102 and/or sensors 204 may be used alone or in combination.

Cloud Platform

The cloud platform 104 may include one or more servers (such as Internet servers) and may include all of the components (hardware and software) necessary to transmit data to and receive data from the sensor modules 102, and to analyze or otherwise process the data it may receive and/or transmit. For example, the cloud platform 104 may include a CPU, microprocessor, microcontroller, chipset, control board, RAM, general memory, network boards, power supplies, an operating system, software, applications, scripts and any other component, application, mechanism, device or software as required. The cloud platform 104 may also include a software system/platform 106 (described in more detail below). The cloud platform 104 may generally receive data transmitted by the sensing module 102 for analysis and/or processing via software system/platform 106, and may also transmit information, commands or other types of data to the sensing module 102. The cloud platform 104 may communicate with the sensor modules 102 through an Internet connection (e.g., via a modem through a service provider) that may include a wireless connection such as Wi-Fi via an Internet modem and router, via network cables or transmission lines, or by other means.

The cloud platform 104 may include drivers to control the different types of sensor modules 102 that may employ different types of sensors 204. The cloud platform 104 may receive sensed data from each sensing module 102, may store the data in a database or in other types of data filing architectures within its memory, and may analyze the data according to appliance models of operation, criteria, rules or other types of parameter definitions (this will be described in detail with relation to software system/platform 106). The cloud platform 104 may also download data to another platform or facility where the data may be stored, analyzed, or otherwise evaluated, compared to the criteria of each particular appliance model of operation and/or generally processed. In this way the system 100 may determine if and when an appliance intervention may be required.

Note that the cloud platform 104 may receive data from and/or transmit data to one or more sensor modules 102 at a time, simultaneously and in real time. In this way, a multitude of sensor modules 102 may be configured with a variety of appliances 110 and all be controlled and monitored by one or more cloud platforms 104. It may be preferable that each sensing module 102 have a unique identifier (such as a serial number, IP address or other type of unique identifier) and that the cloud platform 104 may recognize each unique sensing module 102 identifier and control each sensing module 102 individually. It may also be preferable that each appliance 110 also has a unique identifier such as a serial number and that the cloud platform may recognize each unique appliance 110 identifier. In this way, the cloud platform 104 may organize and manage the data for each sensing module 102 and appliance 110, identify the exact appliances 110 that may require an intervention, and may schedule, initiate and generally execute the intervention accordingly.

It should be noted that cloud platform 104 may perform some or all of the operations and functionalities described above using software system/platform 106 (described below).

Local Controller

As noted, the system 100 may include a local controller 108. The local controller 108 may include a computer, a smartphone, a tablet computer, a laptop, a personal computer, a hub, a server or any other type of controller or combination thereof. The local controller 108 may also include a transmitter/receiver such that it may communicate with the sensor modules 102 and/or the cloud platform 104. The local controller 108 may be configured and positioned in the local proximity of the sensor modules 102 and appliances 110 and configured therewith. The local controller 108 may include some or all of the functionalities of the cloud platform 104 such that the functionalities (e.g., the appliance data analyses and/or processing) may be performed locally on the local controller 108 as desired instead of in the cloud platform 104. This may be required if an Internet connection to the cloud platform 104 is not available or if it is not desirable to be connected to the Internet or to an outside network for the particular appliance 110 being monitored (e.g., due to security or privacy reasons). As such, the local controller 108 may also include software system/platform 106 that will be described in later sections.

The local controller 108 may be networked, paired or otherwise configured with the sensor modules 102, and may communicate with the sensor modules 102 via wireless technologies, Wi-Fi, Bluetooth, RF, microwave, optical or other types of wireless technologies. Alternatively the local controller 108 and the sensor modules 102 may communicate via transmission lines or cables, or via any combination thereof.

In this way, the local controller 108 may have the capability to perform all of the same functionalities as the cloud platform 104.

Note also that the local controller 108 may also communicate with the cloud platform 104 such that it may relay data from sensor modules 102 or other information to the cloud platform 104 as desired and/or as necessary. In one example, local controller 108 may collect and generally aggregate data from the sensing modules 102 and then periodically upload the data to the cloud platform 104. In this way, system 100 may reduce the amount of bandwidth that it may require and/or utilize.

The local controller 108 may also include visual or audio notifications that may alert the user to various operating conditions. For example, the local controller 108 may include a first LED indicator light that may indicate that the local controller 108 and its associated sensing module 102 may be operating correctly. The local controller 108 may also include a second LED indicator light that may indicate that there may be a problem with the local controller 108 or the sensing module 102 or with any other component of system 100. Yet another indicator light may indicate that the sensing modules 102 may be on the network and communicating with the cloud platform 104, or that there may be a problem with the network or Internet connection. Other types of indicator lights may also be used for other types of indications.

It should be noted that local controller 108 may perform some or all of the operations and functionalities described above using software system/platform 106, as described below.

Software System/Platform

The software system/platform 106 may be installed and run on the cloud platform 104 and/or a local controller 108, and may act as a secure central point for each sensing module 102 to transmit data. The software system/platform 106 may be used by the cloud platform 104 and/or the local controller 108 to receive and analyze the data from the sensor modules 102, and to provide guidance and execution of any necessary interventions for any particular appliance 110, as necessary.

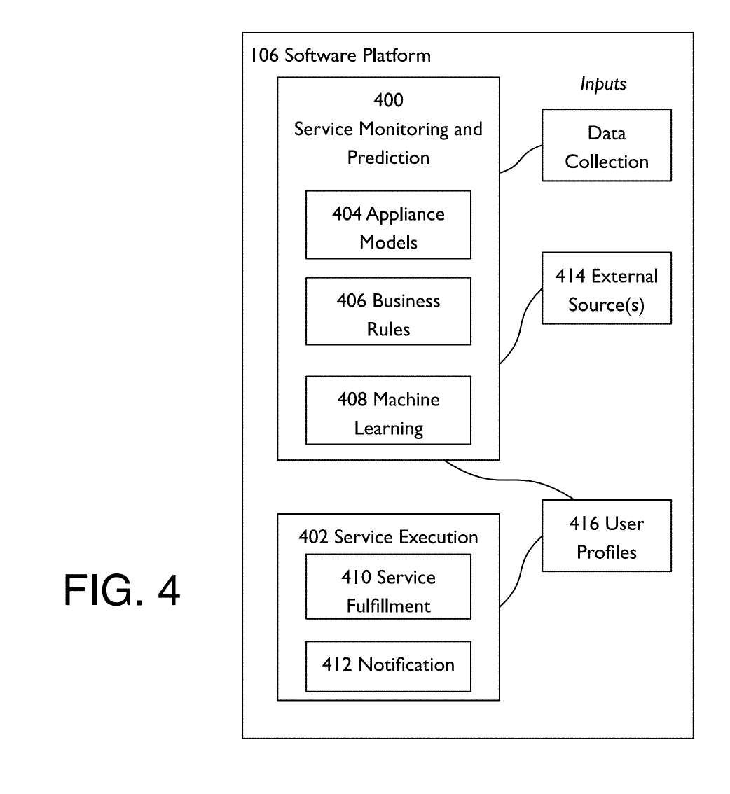

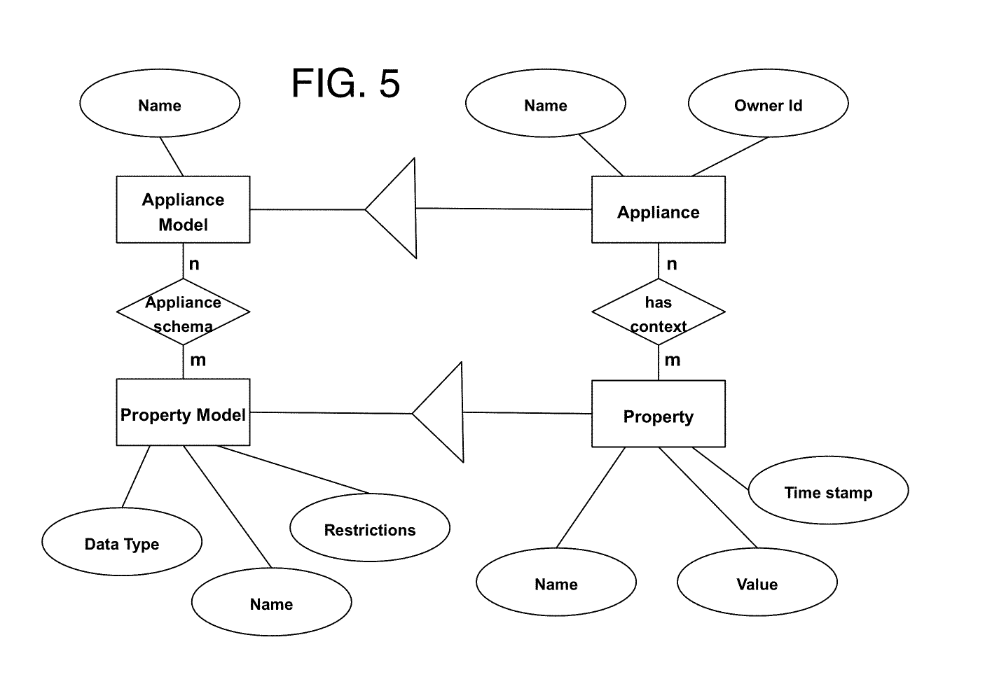

With reference to FIG. 4, a software system/platform 106 according to exemplary embodiments hereof may include a service monitoring and prediction module 400, a service or intervention service execution module 402, and other modules that may be necessary for it to perform its required functionalities. The service monitoring and prediction module 400 may be configured to receive information (e.g., sensed appliance data) from the sensing modules 102 and may analyze the data in an effort to determine or otherwise predict if and when a particular appliance 110 being monitored may require an intervention. Upon determining that an intervention may be required, the service monitoring and prediction module 400 may provide relevant information regarding the appliance 110 to the intervention service execution module 402 that may then initiate and execute the recommended intervention.

The service monitoring and prediction module 400 may include an appliance models module 404, a business rules module 406, a machine-learning (ML) module 408, and other types of modules that may assist in the analysis of appliance data.

The appliance models module 404 may include stored models of operation for each appliance 110 (or type of appliance) that may be used to determine the current condition of the appliance 110 and to predict when the appliance 110 may require an intervention. The models of operation may include documented outputs for each individual appliance 110 that may be compared to the sensed outputs received from the sensing modules 102. In one example, the sensed information about a particular appliance (e.g., a sensed vibration intensity level) may be compared to the expected outputs of the appliance model (e.g., a documented expected vibration intensity level) to determine if the sensed information falls within the expected model of operation or if the sensed output indicates that the appliance 110 may be operating outside the expected model. If the comparison of sensed data to expected data indicates that the appliance may have a problem or may require an intervention as described above, software platform 106 may initiate the determined intervention. In another example, the models of operation for a particular appliance 110 may be used to track the wear of a particular component within the appliance that may have a predictable life cycle. In this way, the monitoring and prediction module 400 may predict when the component may be approaching the end of its life cycle, and may initiate an intervention to have it replaced before it does.

The appliance models may also include other information regarding the appliances 110 such as the type or general classification of each appliance 110, the various properties that may be monitored by sensing modules 102 (i.e. property models), the property values that may be expected (including data types, data ranges, etc.) and other types of information. The property models may define the data types that may be sensed by sensing modules 102 and analyzed by software platform 106. It may be preferable and important for each appliance model of operation to be designed generally to represent each appliance 110 such that each appliance 110 may generally conform to its respective appliance model during normal operation.

The models of operation may be developed, determined or otherwise created by the manufacturer of the particular appliance 110 during the design, prototyping, manufacturing and quality assurance stages or during any other time in the life cycle of the appliance 110. The models may be based on empirical data or on theoretical data derived from design models of the appliances 110. In any case, a manufacturer may determine and otherwise provide a preferably comprehensive model of operation for each appliance 110 that may be used to classify, categorize, catalog, or otherwise be compared to actual sensed appliance data provided to the software platform 106 by the sensing modules 102.

The software system/platform 106 may also allow for appliance models to be enhanced or otherwise constructed from collective knowledge from similar models/versions/types of appliances 110 that may generally represent the different appliances 110. The software system/platform 106 may also receive and generally input information from external sources 414 such as newly updated appliance models that may be uploaded to system/platform 106 and installed (e.g., on cloud platform 104).

User profiles 416 (e.g., profiles of owners or general stakeholders of particular appliances 110) may also be input into software system/platform 106. In this way, the software and the models may be continually updated and maintained as up-to-date as new appliance data may become available. It may also be preferable that software system/platform 106 allows for the manual tuning or editing of the appliance models through human interaction (e.g., by use of an admin dashboard or other type of interface or dialog configured with software platform 106).

The machine-learning (ML) module 408 may include a system whereby the appliance models may be updated and/or improved using knowledge learned from prior sensed data, measurements, predictions, interventions, user inputs, and/or other activities associated with the use of system 100. The machine-learning module 408 may store and maintain historical data taken from the appliances 110 (or from similar classifications of the appliances 110 that may also be applicable) and may correlate the historical data with prior predictions made. As known in the art, machine learning may provide system 100, cloud platform 104 and/or local controller 108 the ability to learn and optimize the system's intervention criteria without being explicitly programmed. Machine-learning module 408 may include algorithms, scripts, software programs, applications or other mechanisms that may use historical data from prior appliance monitoring, known or acquired patterns of operation or behavior of each appliance 110, or other types of sample inputs to update and continually optimize the appliance models within the appliance module 404. This may also be referred to as predictive analytics. By applying lessons learned from prior monitoring, data analyses, comparisons, interventions and other events, machine-learning module 408 may use statistical analyses to help make data driven optimizations of the appliance models and to the criteria used for intervention decision making. In this way, by feeding or generally applying historical data and past predictions as input data into the models of operation, the software platform 106 may learn from previous predictions to improve future intervention criteria. Given this system, the models of operation for each appliance may improve in specificity, accuracy and comprehensiveness over time.

Note that the software system/platform 106 and/or the machine-learning module 408 may also store and maintain information regarding appliance problems that may not have been initially predicted by the monitoring and prediction module 400. That is, e.g., if an appliance 110 develops or generally exhibits a problem that was not predicted using the models of operation or other criteria, the sensing data that may have been collected prior to and during the appliance 110 problem may be analyzed and classified as indicative criteria of the newly exhibited problem. In this case, the data may be added to the criteria and rule based system of the monitoring and prediction module 400 such that future sensed data or measurements that represent similar data may trigger an intervention.

For example, a particular temperature variation that may be sensed or measured by a sensing module 102 for a particular appliance 110 that indicates a particular problem with the appliance 110 may be added to the appliance model once it has been learned. In this example, the temperature variation may not have been included in the original appliance-operating model by the manufacturer. As such, the temperature variation may not have flagged or otherwise triggered an intervention. However, upon learning that indeed the temperature variation was indicative of a pending problem with the appliance 110, the machine-learning module 408 may add the temperature variation data as a new rule or criteria for initiating an intervention for the appliance 110.

Note that this example and the descriptions above are meant for demonstration purposes and that those of ordinary skill in the art will realize and appreciate, upon reading this description that the machine learning system 408 is not limited to only those examples described. In fact, the machine learning system 408 may be applied and/or utilized by software system/platform 106 in any way or configuration that may allow for the software system/platform 106 to generally learn and improve upon its monitoring and prediction functionalities as described in this description. It can also be appreciated that the machine learning module 408 may include the highest technology and state-of-the-art machine learning algorithms, software, applications and other mechanisms such that machine learning module 408 may efficiently perform its intended functions.

The business rules module 406 may include business conditions that the monitoring and prediction module 400 may use and generally consider when making predictions on the need for appliance interventions. These rules may include information regarding the environments in which the appliances 110 may reside as well as other types of conditions. For example, the data may include meteorological data, or information reflecting that the appliances may be deployed indoors. Other types of information may include the number of hours per day that the appliances may operate, the humidity levels, the temperature ranges, as well as any other type of information that may be relevant. In one example, it may be known that a particular wind turbine may reside in a particularly harsh environment such that it may require more frequent maintenance compared to other similar wind turbines that may be deployed in less harsh environmental conditions. In this case, the particular wind turbine that may reside in the harsh environmental conditions may have an amendment made to its model of operation to account for this condition. For example, its model may include parameters, criteria and/or rules that may be stricter than normal wind turbine models such that it may be flagged earlier for interventions compared to other appliances 110. This may be because the wind turbine in the harsh conditions may degrade faster such that when indications of degradation are first determined it may require quicker service.

Once the monitoring and prediction module 400 of software platform 106 determines that an intervention for a particular appliance 110 may be necessary, it may relay the necessary information regarding the appliance 110 to the intervention service execution module 402. This information may include the recommended type of intervention/service that may be required (for example, a service/maintenance call by an onsite technician, the ordering of parts or consumables for the appliance 110, the replacement of the appliance 110, or other types of interventions). The relayed information may also include the sensing data taken by sensing modules 102 for the particular appliance 110 that may indicate a particular potential problem or service requirement of the appliance 110. Other types of information may also be provided by the monitoring and prediction module 400 to the intervention service execution module 402, as necessary.

Once the service module 402 has been notified that an intervention may be required for a particular appliance 110, it may initiate and generally execute or fulfill the intervention. The intervention service execution module 402 may include an intervention or intervention service fulfillment module 410 and a notification module 412, as well as other modules that may be required for it to perform its functionalities.

The intervention or intervention service fulfillment module 410 may generally include the ability and all the information necessary to initiate, fulfill or generally execute any type of intervention/service that may be required for any particular appliance 110. For example, if a particular appliance 110 may require an onsite service call by a repair technician, the intervention service fulfillment module 410 may include the ability and necessary information to contact the service entity and schedule the onsite maintenance call. The intervention service fulfillment module 410 may also include the ability to pay for the service call as necessary, to follow up with the service entity to confirm that the service has been completed, to schedule additional service calls as necessary, to order and pay for replacement parts for the appliance 110 upon the recommendation of the service entity, or any other type of action that may be required to fulfill the required appliance intervention.

In another example, the service monitoring and prediction module 400 may determine that a 3D printer may require a new plastic resin cartridge, and it may communicate this need to the intervention service fulfillment module 410. Upon receiving this notification, the intervention service fulfillment module 410 may look up the type of cartridge that the particular appliance 110 may require (in this case, the new cartridge for the 3D printer), and may order the cartridge. The intervention service fulfillment module 410 may include the shipping information so that it may arrange for the replacement cartridge to be shipped to the correct address.

Accordingly, it can be seen that software system/platform 106 may include one or more databases that may include a multitude of information and data such as cross correlations of different types of appliances 110, service actions that may be performed on each appliance 110, service entities that may be located within the geographical proximity to each appliance 110 and that may be contacted or generally scheduled to perform the service that may be required, replacement parts for each appliance 110, distributors or sellers of the replacement parts, contact information (i.e. shipping address) for each appliance and/or its stakeholder, credit card or other financial payment information for each appliance stakeholder, or any other type of information that may be required to initiate, manage, fulfill, confirm and generally execute each intervention.

Note that the intervention service execution module 402 may also include fulfillment or execution models that may describe the resources or actions that may be necessary or required to fulfill the different types of interventions/services for the different appliances 110. For example, the intervention service execution module 402 may include fulfillment models for appliances 110 that may require the ordering of replacement consumables, fulfillment models for appliances 110 that may require onsite calibration or maintenance, fulfillment models for appliances 110 that may require replacement after a particular amount of time, or other types of fulfillment or execution models. In this way, the intervention service fulfillment module 410 may use the fulfillment models as guidance or instructions when performing the execution of different interventions for different appliances 110. The models may be defined or generally developed by the manufacturer of the appliances 110, may be updated or edited by the user or stakeholders of the appliances 110, may be optimized or updated using machine learning similar to the machine learning module 408 described in relation to the monitoring and prediction module 400, or by any other means.

The notification module 412 may notify the user, owner, or other stakeholders of the appliance 110 that the appliance 110 may be exhibiting a potential problem and that an intervention may be required. The notification module 412 may also allow for the approval of the intervention to be required prior to the intervention being fulfilled. In this case, the notification module 412 may contact the stakeholder, may provide him/her with the information of the prediction and/or potential situation, and may generally ask for approval to proceed with the suggested intervention. The notification may occur via text messaging, email, voice call, through a mobile application, via a website, or through other communication means or methods. The stakeholder may respond with the requested approval upon which the intervention may be executed by the intervention service fulfillment module 410, or the stakeholder may not approve the intervention such that the system 100 may then await further instructions or guidance.

Upon the fulfillment of the intervention, the notification module 412 may notify the stakeholders that the intervention was successfully completed, or if there were problems, may inform him/her of the problems. The notification module 412 may also provide further details regarding the exact intervention that may have been performed and the findings of the intervention. These findings may be important for future operation, maintenance and general usage of the appliance 110, or for other uses.

Mobile Application (App)

As shown in FIGS. 1A-1C, system 100 may also include a device 112 such as a mobile phone, a tablet computer, a laptop computer or other type of device that may be separate and distinct from the local controller 108. The device 112 may include an application 114 (e.g., a mobile app) that may be configured to communicate with system 100.

The application 114 may provide a variety of functionalities related to the system 100. For example, the application 114 may allow the user of system 100 to initialize, test, troubleshoot and generally configure sensing modules 102 with appliances 110. The application 114 may allow for a sensor module 102 to confirm that it may be operating properly. Alternatively, if there is a problem with sensing module 102, or with any other component or element of system 100, the application 114 may notify the user.

In addition, an exemplary application 114 may provide a platform for notifications module 412 to communicate with the user or other stakeholder of the appliance 110 as described above. In this way, the application 114 may receive notifications from the software platform 106 regarding the interventions or other activities that may be associated with the system 100 that a user may be using.

An exemplary application 114 may also include a variety of other functionalities such as providing sample appliance data to the user on a schedule or continually throughout the day. The application 114 may also allow the user to communicate with the cloud platform 104 and/or the local controller 108 and to receive data and information regarding the appliances 110 from those platforms. It can be appreciated that application 114 may include other functionalities associated with the use of system 100 that may not be listed above, but that may be useful during the operation of system 100.

In another alternative, device 112 may not be required and local controller 108 may include the application 114 to perform the functionalities described above.

Workflow

An exemplary workflow of configuring and using system 100 may consist of the steps shown below. Note that other steps not listed may also be used and that the steps may be performed in other orders.
1. The sensing modules 102 may be initially set up and generally paired with a given appliance 110.
2. The sensing modules 102 may monitor the appliances 110 as described above, and may communicate the appliance data with the cloud platform 104 and/or the local controller 108 accordingly.
3. The software system/platform 106 may aggregate, store, analyze, and generally process the sensed data taken by the sensing modules 102 and communicated to the software platform 106.
4. The software system/platform 106 may predict or otherwise identify the need for appliance interventions and may initiate, execute, manage, confirm and otherwise fulfill the required interventions.
5. The system 100 may also communicate with the user or general stakeholder of the appliances 110 in order to inform him/her of conditions that may apply to the appliances 110 such as but not limited to the problems that may have occurred with the appliances 110, interventions that may have been fulfilled, maintenance that may have been performed, replacement parts that may have been ordered and installed, confirmations that the appliances 110 may have been repaired and are generally back online, or other types of information.

Discussion

As explained, sensed information, alone or in combination with other information (e.g., historic data), may represent or indicate the need for an appliance intervention. For example, a vibration sensor 204 in sensing module 102 configured with an appliance 110 may sense a particular type of vibration from/of the appliance 110. In this example, the sensed vibration may have a level and/or intensity and/or frequency that may differ from normal expected vibration levels for the particular appliance 110 such that it may indicate a potential problem with the appliance 110. The sensing module 102 may process this event via its controller 200 and transmit the event data (the sensed appliance data) to the cloud platform 104 and/or the local controller 108 via its networking/communications module 202.

Event data associated with a particular appliance and sensed by a sensing module 102 may be received by the cloud platform 104 and/or the local controller 108, and may be stored, analyzed and/or otherwise processed by software system/platform 106. In general, the sensed information associated with an appliance may be analyzed by software system/platform 106 to determine if the particular appliance may currently or in the future require an intervention. In addition, the data may be used to predict future conditions of the appliance 110 (e.g., a potential breakdown) that may be avoided by an appropriate appliance intervention (e.g., preventative maintenance). Examples of such interventions may include but are not limited to one or more of: (i) a maintenance-service call for the appliance 110 to be repaired, (ii) a service call for the appliance 110 to be calibrated, (iii) an order for consumables required by the appliance 110, (iv) a service call to perform preventative maintenance on the appliance 110. Note the types of interventions listed above do not limit system 100 in any way and that those of ordinary skill in the art will realize and appreciate, upon reading this description, that different and/or other types of interventions may also be identified, initiated, and/or executed by system 100.

In general, system 100 may ascertain aspects of the current condition of an appliance 110 via one or more sensing modules 102, and then predict one or more potential future conditions of the appliance 110 that may possibly be avoided or mitigated by an appliance intervention. In this regard, the potential future condition(s) that system 100 may predict may be a condition that may be avoided or mitigated, such as, e.g., the breakdown of the appliance 110, or depletion of consumables that the appliance may require to operate. Accordingly, it may be preferable that upon predicting a potentially unfavorable future condition, an intervention (that may help to prevent avoid or mitigate the unfavorable expected future condition) may be recommended and executed. For example, preventative maintenance may help to avoid an appliance breakdown, or the ordering of appliance consumables prior to their depletion may avoid downtime due to the lack of supplies.

Upon identifying one or more appliance events that may require one or more interventions, software system/platform 106 may execute or initiate one or more interventions. For example, software system/platform 106 may schedule a service call for a repair technician to go onsite and repair an appliance that may have been determined to have a broken part. In this example, software system/platform 106 may send an email to the repair technician requesting the service call. The email may provide the contact information of the owner of the appliance and may ask the technician to contact the owner directly to schedule the onsite appointment. Other types of communication tools may also be used. In another example, software system/platform 106 may order the replenishment of consumables that are expected to run out (such as ink for a printer). For example, in the case of a printer running low on ink, software system/platform 106 may have the ability to order the required ink cartridge from an online supplier, pay for the transaction, and have the replacement ink cartridge shipped directly to the owner of the printer. In general, the system 100 may monitor the appliances 110, record and process information determined while sensing the appliances, predict a future condition of the appliances 110 based on sensed data (e.g., the onset of a breakdown or the need for a replenishment of consumables), and initiate a required intervention. The types of interventions that system 100 may execute or initiate are not limited to these examples as would be immediately recognized by one of ordinary skill in the art. Other examples of interventions that may be executed by system 100 are described in detail below.

As an example, the manufacturer of a refrigerator unit with built-in water dispensers may wish to predict when a water filter may need to be replaced. To accomplish this, refrigerators already deployed into homes may be configured with a sensing module 102 that may include an audio sensor 204 that may listen to the sound of the water flowing through the filter. The sensor 204 may be calibrated such that it may correlate the sensed audio with the amount of water that is being dispensed over time. The refrigerator manufacturer may define a predictive model that may be used as criteria and to identify when the water filter may require replacement. Once it may be determined that the filter needs replacement, the system 100 may notify the user or may automatically initiate the replacement. The predictive model may be first trained based on historic data the manufacturer may have already collected, and by using published research data such as the per capita water use. Over time, this model may be updated based on the collective sensed data or measurements of multiple like water dispensers. The purpose of the system 100 in this example may be to improve consumers' health by providing an automated and personalized water filter replenishment service, based on individual usage history and learned prediction models. In addition, the system 100 may also ensure that the new filter is genuine, based on the particular sound the filter may emit when in operation as well as sensory footprints detected over time.

Multiple distinct sensing modules 102 may be treated as a logical network or group of related sensors. Such grouping of sensing modules 102 (or sensors 204) may be used, e.g., to determine and act on information from related appliances 110. For example, in such cases, an intervention informed by one or more of the related sensors 204 may be applied to appliances 110 associated with other sensors 204 in the network or group. Sensors 204 (or sensor modules 102) may be considered related (and thus in a logical network or group of related sensors 204) based on one or more factors (e.g., the type of appliance 110, geographical proximity, etc.). A particular sensing module 102 may be in multiple logical networks or groups.

As an example, a network of distinct sensing modules 102 in a particular geographic area or neighborhood may be used to prevent water leaks in winter. If water leaks are detected in some houses in the neighborhood (e.g., in houses connected to the same cloud platform 104), a preventative intervention may be instigated for all members of the network (i.e., for all sensing modules 102 in the network). As should be appreciated, the preventative intervention may thus be instigated for houses that have not (or not yet) detected a water leak. Thus, a local sensor 204 that has not detected a water leak may be notified that to shut-off a water conduit preventively (because it is highly probable that they will also have a water leak soon).

Example Use Cases

The table below contains a list of exemplary use cases of a system according to exemplary embodiments hereof. Note that those of ordinary skill in the art will realize and appreciate, upon reading this description, that the current invention is not limited in any way by these use cases and that any number of other use cases also exists. The list below is only meant for demonstrative purposes to aid this description.

| Appliance | Monitoring Features | Automated Services |
|---|---|---|
| Coffee machine | Vibration | Replenishment of coffee |
| | Duration | beans |
| Wind turbine | Sound | Replacing parts |
| | Vibration | Preventive maintenance |
| | Wind | |
| | Dust | |
| Water cooler (or | Sound | Replenishment of water |
| water dispensing | Vibration | filter |
| fridge) | | Replenishment of bottled |
| | | water (if water cooler |
| | | uses bottled water) |
| Whole house | Sound | Replenishment of air filter |
| filtration systems | Vibration | Preventive maintenance |
| | Humidity | |
| Boiler | Carbon monoxide | Pre-ordering of replacing |
| | Vibration | parts |
| | | Preventive maintenance |
| | | Ensuring replaced parts are |
| | | genuine |
| Postbox | Sound | Postbox emptying |
| | Weight | |
| | Vibration | |
| Dishwasher | Vibration | Replenishment of detergent |
| | Duration | Replenishment of water |
| | Sound | softener |
| | | Maintenance |
| Moldy homes | Humidity | Maintenance |
| Vacuum cleaner bag | Vibration | Replenishment of dust bag |
| | Sound | |
| | Duration | |
| Dryer filter | Humidity | Replenishment of filter |
| Washing machine | Vibration | Replenishment of detergent |
| | Duration | |
| | Sound | |
| Sparkling water or | Temperature | Maintenance |
| soda dispenser | Sound | Replacement of solenoid |
| | Vibration | valve |
| | | Replacement of Carbon |
| | | Dioxide cartridge |
| | | Ensuring cartridge is |
| | | genuine |
| Oven filter | Temperature | Replenishment of oven |
| | Carbon monoxide | filter |
| Cat basket/toilet | Methane | Replenishment of cat sand |
| Dog food | Pressure | Replenishment of dog food |
| | Sound | |
| | Duration | |
| Refrigerator | Temperature | Pre-ordering of compressor |
| | Vibration | Schedule maintenance |
| | Duration | Re-ordering of water filters |
| | | Ensuring water filters are |
| | | genuine |
| Air conditioner | Ambient | Pre-ordering of compressor |
| | temperature | Schedule maintenance |
| | Humidity | |
| | Vibration | |
| | Duration | |
| Central heating pellet | Ambient | Replenishment of wood- |
| boiler | temperature | pellets |
| | Humidity | Maintenance |
| | Season | |
| | Barometric pressure | |

Example Use Cases

Various sample use cases of exemplary systems according to exemplary embodiments hereof are described here in greater detail. Note that the examples described below are meant for demonstration purposes only and that those of ordinary skill in the art will realize and appreciate, upon reading this description that the system of the current invention is not limited to only those examples described. As should be appreciated, the system of the current invention may be applied to a wide variety of appliances and/or systems whether or not the specific appliances and/or systems are described in this description.

Coffee Machine

Motivation:

A coffee machine should never run out of coffee.

Method:

The amount of coffee used may be predicted through the sensing or measurement of the vibration strength and duration, and by the global order of events.

Approach:

A sensing module 102 including a vibration sensor 204 may be configured with a coffee machine to detect the duration and strength of vibrations that may emit from the coffee machine during the grinding of the coffee beans. The sensing module 102 may transmit sensed/measurement data over a network to the cloud platform 104 and/or local controller 108 through LPWAN, Wi-Fi, Ethernet, or by other means.

An appliance model for the type of coffee machine that may be monitored may reside within the software platform 106 as described above.

The sensing module 102 may transmit sensed/measurement data to the software platform 106 every time a person interacts with the machine. It may be known by the model of operation of the coffee machine within software platform 106 that changing water or emptying the tray may emit short duration vibrations, and that the making of coffee may consist of two long vibration phases (corresponding to the grinding of coffee, and then the pumping of hot water through the grinded coffee). Accordingly, the sensing module 102 may transmit the sensed/measured data to the software platform 106 that may represent the two long vibration phases, or the sensing module 102 may transmit all of the sensed/measured data to the software platform 106 that my parse out and process only data pertaining to the two long vibration phases. In this way, the system 100 may aggregate data pertaining to the making of the coffee in order to ascertain when the coffee beans may run out. The data may also be permanently stored for the given appliance.

If the software platform 106 predicts that the current supply of coffee beans will soon be depleted, an intervention that may include a reorder process may be triggered.

Upon delivery, the customer may scan a (2D) barcode on the sensing module 102 or on the pack of coffee to confirm that the replenishment has been successful. This may reset the digital record within software platform 106 pertaining to the level of coffee beans of the appliance 110.

Water Cooler

Motivation:

Prevent bacteria buildup in water filters (for water coolers) that harm people's health by automatically ordering a new water filter when a water filter is approaching its end of life.

Method:

The amount of water processed by a filter may be predicted based on the sound intensity and duration of running water and the sound water may make when interacting with a container, such as a glass.

Approach:

A sensing module 102 including a sound sensor 204 may be configured with a water cooler to detect the duration and strength of audio signals that may emit from the water cooler during the dispensing of water. The sensing module 102 may be placed close to the water dispensing valves on the cooler. The sensing module 102 may transmit sensed/measurement data over a network (LPWAN, Wi-Fi, Ethernet, etc.) to cloud platform 104 and/or local controller 108.

An appliance model for the type of water cooler that may be monitored may reside within the software platform 106 as described above.

The sensing module 102 may transmit data each time water is dispensed. The sound sensor 204 may react to frequencies of water flowing and water hitting an empty glass or cup as the cup is being filled. The duration and amplitude of the sensed/measurement data may be transmitted to the cloud platform 104 and/or the local controller 108. In this example, software platform 106 may use the measurement data to infer the amount of water dispensed over time and may compare the amount of water with the life cycle specifications of the water filter.

If the software platform 106 predicts that the currently installed filter may have reached its end of life cycle and may need replacement, an appliance intervention that may include a replenishment order may be triggered.

Dishwasher

Motivation:

Enable a dishwasher to clean dishes with minimal use of water, detergent, or water softener by ensuring a reliable supply of detergent and water softener is always available.

Method:

The duration of a washing cycle may be detected based on the duration of the vibrations intensity. Sound patterns can be grouped by activity of the dishwasher.

Approach:

A sensing module 102 including a sound sensor 204 and/or a vibration sensor 204 may be configured with a dishwasher to detect the duration and strength of vibrations that may emit from the dishwasher during its cleaning cycle. Because a dishwasher may make more noise than a water cooler in the prior example, there may be more flexibility as to where the sensing module 102 may be placed on the appliance 110. The sensing module 102 may transmit sensed/measurement data to the cloud platform 104 over a network (LPWAN, Wi-Fi, Ethernet, etc.) or by other means. In this example, it may be important to verify that the dishwasher does not shield the sensing module 102 from the wireless network. If in fact the module 102 may be obstructed however, the sensing module 102 may provide visual feedback (e.g., through the illumination of an LED indicator) to inform the user whether or not the wireless network signal strength may be sufficient to transmit sensed/measurement data.

An appliance model for the type of dishwasher that may be monitored may reside within the software platform 106 as described above.

The sensing module 102 may transmit the duration of vibrations that may have an intensity and duration greater than a predefined threshold. The vibration duration may be used to detect when the dishwasher is running A rule-based reasoner within the software platform 106 may map the duration of a wash cycle to the amount of detergent used. In addition, it may also map the duration of the wash cycle, the model-specific water throughput per second and information about the concentration of multivalent cations in the water to predict the buildup of calcification to the amount of water softener used. In addition to vibration, sound may be sensed and analyzed by software platform 106 to classify sound patterns by activity to determine the state of the dishwasher.

If detergent or water softener supplies are deemed to be low, an intervention such as a replenishment order may be triggered. If the washing machine enters a state that indicates the onset of a breakdown, maintenance may be scheduled.

Automatic Appliance Configuration

Embodiments hereof may be used for automatic appliance configuration. This may be useful, e.g., when an appliance's internal configuration is not known and/or when an appliance is inaccessible.

A machine-learning model may be used to create a catalog of unique appliance patterns based on measurable features such as vibrations, sounds, etc. Once a sensor is associated with (e.g., attached to) an appliance, measurements may be relayed to an appliance classification component, to automatically detect the appliance type. This information may be used to determine the appliance's type and/or configuration. Once the appliance's type and/or configuration is determined, an appropriate configuration profile may be uploaded.

Collective Replenishment Recommendations

Embodiments hereof may use replenishment predictions and replenishment histories from appliances in similar situations to inform individual replenishment decisions. For example, if water dispensers in a given area suddenly require new water filters, then this information may be considered for other water dispensers in that area (even if those other dispensers are not being monitored).

Crowd-Sourced Replenishment

Appliances without sensors may essentially piggyback on a network of appliances of the same type for automatic replenishment. For example, if dryer filters in houses in a given area are experiencing a surge in filter replacements, then dryer filters that do not have a sensor attached in the same area may also be given the option to replenish filters.

### End of Example Use Cases

### DISCUSSION

Exemplary embodiments hereof support some or all of the following, alone or in combination:
Using a customizable add-on sensing hardware module for the purpose of measuring one or more features of the device for a known appliance model allows to map features to a prediction of future state(s) of the appliance.
Measuring features of the appliance in a non-intrusive way, without requiring any modification of the device other than attaching (e.g., magnetic tape) the add-on sensing module to the appliance.
Providing connectivity with the add-on sensors enables to transmit measures to a software platform.
Learning from one and more similar appliances allows to generalize models and provided improved predictions and classifications and evolve machine learning, statistical, algorithmic, models over time.
Learning from one or more similar appliances whether the part that was replaced is genuine.
External data sources (weather reports, temperature readings from smart thermostats) can be fed to the learning component to improve models.
Providing feedback on device for a mixed-initiative approach, in which a user confirms the result of an automatically executed service.
Using formal models (ontologies) allows for a human-controlled and/or monitored use of artificial intelligence.
Make predictions available to a third party to delegate automatic service execution.
Automatic appliance configuration: We use artificial intelligence to create a catalog of unique appliance patterns based on measurable features such as vibrations. Once the sensor is attached to the appliance, measurements are relayed to an appliance classification component, to automatically detect the appliance type and upload the appropriate configuration profile.
Collective replenishment recommendations: embodiments hereof may leverage replenishment predictions and replenishment histories from appliances in similar situations to inform individual replenishment decisions.
Crowd-sourced replenishment: Appliances without sensors may piggyback on a network of appliances of the same type for automatic replenishment.
Remote sensing: Instead of directly attaching a sensor to an appliance, embodiments hereof may also support a sensor observing one or more appliances.

Aspects hereof allow devices or appliances to be monitored with sensing mechanisms that were not part of the original devices or appliances. The sensing mechanisms may sense and/or measure physical properties and/or features that were not necessarily considered when a device or appliance was first manufactured. The sensing mechanisms may allow for enhanced device/appliance monitoring, supporting enhanced preventive maintenance and/or replenishment.

Additionally, the non-intrusive nature of the monitoring may allow for monitoring of one or more devices without interference or intrusion or interaction with the operation of those devices. For example, as noted, sensing mechanisms may be attached to existing devices/appliances (e.g., by a “snap on” or magnetic approach or in some other way) without modifying the devices/appliances.

Various sensors and/or types of sensors are listed herein as examples, including, without limitation, sensors for one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and/or nitrogen. This list of sensors or sensed properties is only exemplary, and those of skill in the art will understand, upon reading this description, that different and/or other sensors and/or combinations thereof may be used and are contemplated herein. The scope hereof should not be limited by the type of sensor(s) used or by the physical property or properties they measure.

Various appliances and/or types of appliances are listed herein as examples, including, without limitation, coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters. The appliances listed herein are only exemplary, and those of skill in the art will understand, upon reading this description, that different and/or other appliances and/or combinations thereof may be used and are contemplated herein. The scope hereof should not be limited by the appliance(s) or type(s) of appliance(s).

Data Model

An exemplary data model is shown in FIG. 5.

### CONCLUSION

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

We claim:

1. A system comprising:
a controller including hardware comprising at least one processor and a memory, and controller constructed and adapted to:
(a) receive information from at least one sensor, wherein said at least one sensor is constructed and adapted to sense, non-intrusively, real-world physical information associated with at least one appliance;
(b) based at least in part on said information from the at least one sensor,
(b)(1) determine a current condition of the at least one appliance and/or
(b)(2) predict a future condition of the at least one appliance; and
(c) based at least in part on (i) said current condition of the at least one appliance determined in (b)(1) and/or (ii) said predicted future condition of the at least one appliance determined in (b)(2), initiate at least one intervention with the at least one appliance.

2. The system of claim 1, wherein
said at least one sensor is constructed and adapted to sense real-world physical information associated with said at least one appliance without interaction or interference or intervention, operationally or functionally, with said at least one appliance.

3. The system as in claim 1, wherein the real-world physical information associated with at least one appliance includes information associated with the at least one appliance's environment.

4. The system as in claim 1, wherein the at least one sensor senses one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and nitrogen.

5. The system of claim 1, wherein the at least one appliance is selected from a group comprising: coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters.

6. The system of claim 1, wherein one or more sensors of said at least one sensor is associated with multiple appliances of said at least one appliance.

7. The system of claim 1, wherein multiple sensors of said at least one sensor are associated with a particular appliance of said at least one appliance.

8. The system of claim 1, wherein the at least one intervention comprises one or more actions selected from a group comprising: turn off said at least one appliance, initiate replenishment of a supply of said at least one appliance, initiate service or maintenance of said at least one appliance, initiate replacement of a part of said at least one appliance, configure said at least one appliance, and provide information about said appliance to a third party.

9. The system of claim 1, wherein said future condition of the at least one appliance is predicted in (b)(2) based on one or more of: information learned from other appliances, prior sensed data, measurements, prior predictions, manufacturer models, and external sources.

10. The system of claim 9, wherein said external sources include one or more of: weather reports, temperature readings from thermostats, manufacturer data.

11. The system of claim 1, wherein said at least one sensor is constructed and adapted to non-intrusively sense real-world physical information associated with said at least one appliance.

12. The system of claim 1, wherein one or more sensors of said at least one sensor are add-ons to one or more of said at least one appliance.

13. The system of claim 1, wherein one or more sensors of said at least one sensor are attached to one or more of said at least one appliance.

14. The system of claim 1, wherein one or more sensors of said at least one sensor are apart or remote from one or more of said at least one appliance.

15. The system of claim 1, wherein said controller is further constructed and adapted to:
(d) initiate at least one intervention with at least one non-monitored appliance based, at least in part, on (i) a current condition of at least one monitored appliance determined in (b)(1) and/or (ii) a predicted future condition of at least one monitored appliance determined in (b)(2).

16. The system of claim 1, wherein said predicted future condition of the at least one appliance is determined based on a history of other appliances.

17. The system of claim 1, wherein the controller receives information in (a) wirelessly from at least some of the at least on sensor.

18. A computer-implemented method, on a controller including hardware comprising at least one processor and a memory, the method comprising, by the controller:
(A) receiving information from at least one sensor, wherein said at least one sensor is constructed and adapted to sense, non-intrusively, real-world physical information associated with at least one appliance;
(B) based at least in part on said information from the at least one sensor,
(B)(1) determining a current condition of the at least one appliance and/or
(B)(2) predicting a future condition of the at least one appliance; and
(C) based at least in part on (i) said current condition of the at least one appliance determined in (B)(1) and/or (ii) said predicted future condition of the at least one appliance determined in (B)(2), initiating at least one intervention with the at least one appliance.

19. The method of claim 18, wherein said at least one sensor is constructed and adapted to sense real-world physical information associated with said at least one appliance without interaction or interference or intervention, operationally or functionally, with said at least one appliance.

20. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of claim 18.

21. A sensor module comprising:
one or more sensors,
a communication mechanism; and
a controller, comprising at least one processor and a memory,
wherein said one or more sensors are constructed and adapted to sense, non-intrusively, real-world physical information associated with at least one appliance, and
wherein said controller:
(a) obtains sensor information from said one or more sensors; and
(b) provides sensor data to a system distinct from said sensor module, wherein said sensor data is based on and/or derived from said sensor information.

22. The sensor module of claim 21, wherein said one or more sensors are constructed and adapted to sense real-world physical information associated with said at least one appliance without interaction or interference or intervention, operationally or functionally, with said at least one appliance.

23. The sensor module of claim 21, wherein said one or more sensors monitor physical aspects of a single appliance and/or an environment of said single appliance.

24. The sensor module of claim 21, wherein said one or more sensors monitor: (i) physical aspects of multiple appliances, and/or (ii) an environment of said multiple appliances.

25. The sensor module of claim 21, wherein said controller provides said sensor data to said system using said communication mechanism.

26. The sensor module of claim 21, wherein the sensor module is an add-on to said at least one appliance.

27. The sensor module of claim 21, wherein the sensor module is attached to said at least one appliance.

28. The sensor module of claim 21, wherein the sensor module is apart from said at least one appliance.

29. The sensor module of claim 21, wherein the at least one appliance is selected from a group comprising: coffee machines, wind turbines, turbines, water coolers, water dispensers, filtration systems, boilers, mailboxes, dishwashers, vacuum cleaners, clothes dryers, dryer filters, washing machines, water dispensers, soda dispensers, ovens, oven filters, pet baskets, pet toilets, pet food dispensers, refrigerators, air conditioners, retail displays, vending machines, and heaters.

30. The sensor module of claim 21, wherein the one or more sensors sense one or more of: temperature, humidity, sound, sound volume, audio frequency, radiation, electromagnetic radiation, light, orientation, vibration, movement, speed, acceleration, motion, pressure, microwaves, millimeter waves, electric current, voltage, magnetism, dust, wind, carbon monoxide, weight, ambient temperature, ambient light, radon, mold, carbon dioxide, and/or nitrogen.

31. The sensor module of claim 21, wherein the sensor module operates independent of said at least one appliance.

32. The sensor module of claim 21, wherein the sensing module is configured to continually monitor said at least one appliance.

33. The sensor module of claim 21, wherein the sensing module is configured to periodically monitor said at least one appliance.

34. The sensor module of claim 33, wherein the sensing module is configured to periodically monitor said at least one appliance and then to switch from a periodic monitoring mode to a continual monitoring mode upon sensing a particular output or type of output from the at least one appliance.

35. The sensor module of claim 21, wherein sensing module is configured to continually send data that the sensing module collects from the at least one appliance to the system.

36. The sensor module of claim 21, wherein sensing module is configured to parameterize and/or categorize and/or manipulate and/or filter and/or process sensor information obtained from said one or more sensors prior to sending the sensor data to the system.

37. The sensor module of claim 21, wherein the communication mechanism comprises a receiver, and wherein the sensor module is further constructed and adapted to receive, via said receiver, commands to be processed and/or executed by the controller.

38. The sensor module of claim 37, wherein the commands include a command to switch the sensor module to a low power consumption and/or battery conservation mode.
